(19) United States
(12) Patent Application Publication
(10) Pub. No.: US 2015/0071460 A1
(43) Pub. Date: Mar. 12, 2015

(54) 2-Way Enhanced Live Recording Splicing (ELRS)

(71) Applicant: Nathan K. Stiles, Modesto, CA (US)

(72) Inventor: Nathan K. Stiles, Modesto, CA (US)

(21) Appl. No.: 13/894,154

(22) Filed: Sep. 6, 2013

(51) Int. Cl. H04R 3/00

(52) U.S. Cl. CPC H04R 3/005
USPC 381/92

(57) ABSTRACT

A method of live audio recording intended to enhance the playback performance of vocal, conventional, analog and digital equipment by using both microphones and direct current to recording apparatuses to capture the performance, splicing together two or more recordings and producing them through the use of volume adjustment and/or separate editing equipment or software.

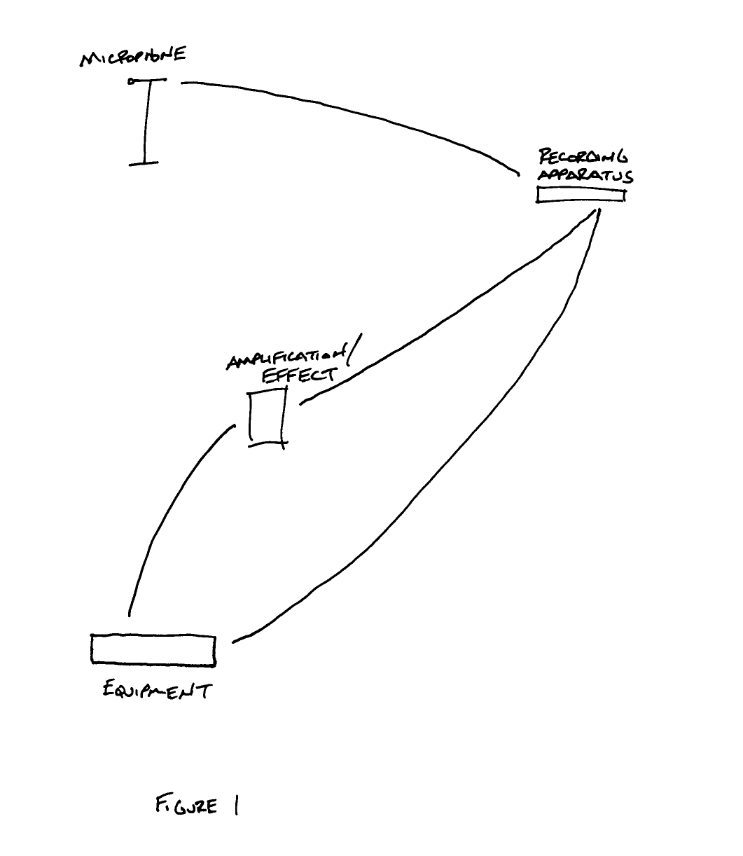

Pertaining to the recording of live instruments and vocals using direct recording mediums as well as through microphones and amplification to produce a more complete tone.

### BACKGROUND

Microphones capture the sound of external noises in the immediate environment surrounding the performer as well as the amplified sound produced by the live instrument.

Conventional equipment produces a tone that is amplified without the use of electrical devices.

Analog Equipment produces a direct current in to the recording apparatus that is void of any effect, external amplification or noises surrounding the immediate environment of the performer.

Digital Equipment produces a direct current that may or may not include effect in to the recording apparatus that is void of external amplification or noises surrounding the immediate environment of the performer.

### SUMMARY OF THE DISCLOSURE

The method of 2-Way Enhanced Live Recording Splicing (ELRS) involves the simultaneous recording of live instrumentation using microphones to capture the sound of external noises in the immediate environment surrounding the performer as well as the amplification of conventional equipment without the use of electrical devices and the direct current of either analog or digital equipment and then splicing the recordings together.

### BRIEF DESCRIPTION OF THE DRAWINGS

The drawings represent the manner in which the microphones, live instruments and recording apparatuses should be configured.

### DETAILED DESCRIPTION

Using one or more strategically placed microphone(s) each microphone can be connected to the recording apparatus on left, right or multiple channels. On a separate channel the live instrument can be connected directly to the recording apparatus or run through devices that produce effects and/or amplification. If recorded simultaneously playback should warrant an enhanced live sound that captures both the sound of external noises surrounding the immediate environment of the performer and the direct current of the live instruments otherwise playback may require volume adjustments and splicing can take place using separate editing equipment or software.

Using the same description for connecting the recording apparatus vocalists and performers using conventional equipment will need the use of 2 or more microphones.

1. A method for recording live audio performances.
